(19) United States
(12) Patent Application Publication
(10) Pub. No.: US 2021/0407732 A1
(43) Pub. Date: Dec. 30, 2021

(54) Composite Material for a Transformer

(71) Applicants: thyssenkrupp AG, Essen (DE); ThyssenKrupp Electrical Steel GmbH, Gelsenkirchen (DE)

(72) Inventors: Christian Hecht, Muelheim an der Ruhr (DE); Ludger Lahn, Moers (DE); Régis Lemaître, Bethune (FR); Carsten Schepers, Raesfeld (DE); Chaoyong Wang, Dortmund (DE); Ingo Rogner, Ingolstadt (DE); Tobias Lewe, Muenster (DE)

(21) Appl. No.: 16/490,212

(22) PCT Filed: Mar. 3, 2017
(86) PCT No.: PCT/EP2017/055068

§ 371 Date: Aug. 30, 2019

(51) Int. Cl. H01F 41/02; H01F 27/25; H01F 27/28; B32B 7/12; B32B 15/01

(52) U.S. Cl. CPC H01F 41/022; H01F 27/25; C08L 33/02; B32B 7/12; B32B 15/011; H01F 27/2847

(57) ABSTRACT

A composite material, in particular for use in a transformer comprising a first and a second grain-oriented electric strip layer and a polymeric layer arranged therebetween is disclosed. The polymeric layer includes a crosslinked acrylate-based copolymer of high molecular weight and has a layer thickness in the range from 3 to 10 μm.

### TECHNICAL FIELD

The present application relates to a composite material, in particular for use in a transformer and a method for producing the composite material according to the invention. In a further aspect, the present invention relates to an iron core and a transformer. Furthermore, the present invention relates to a method for producing an iron core.

### TECHNICAL BACKGROUND

In transformers known from the prior art, grain-oriented electric strip is installed in the form of lamellae. Due to the effect of magnetostriction, these oscillate when an alternating current is applied, which leads to the characteristic buzzing of a transformer. Since transformers are also installed in or near residential areas, additional sound-absorbing measures must be taken to reduce noise pollution. These are very expensive.

Other means known from the prior art that reduce noise pollution are structure-borne sound-absorbing composite sheets, which are installed in transformers. For example, U.S. Pat. No. 6,499,209 B1 discloses a transformer produced from a plurality of composite sheets. The individual composite sheets here consist of two outer magnetic layers and an interposed viscoelastic film that is approximately 25 μm thick and based on a crosslinked acrylic polymer.

Although such systems have the required acoustic properties and suitable adhesion values due to the correspondingly large layer thicknesses, the known systems still do not have the magnetic properties sufficient for use in a transformer and the iron filling factors achievable using these in an iron core. There is therefore further development potential for these composite sheets.

### SUMMARY OF THE INVENTION

The object of the invention is to provide a composite material which is improved with respect to the prior art, in particular to provide a composite material for use in a transformer which has improved properties compared to a monolithic electric strip.

This object is achieved by a composite material having the features of claim 1.

Advantageous embodiments and variants of the invention will become apparent from the dependent claims and the following description.

According to the invention, the composite material, in particular for use in a transformer, comprises a first and a second grain-oriented electric strip layer and a polymeric layer arranged therebetween, wherein the polymeric layer comprises a crosslinked acrylate-based copolymer of high molecular weight and a layer thickness in the range from 3 to 10 μm.

Surprisingly, it has been found that the composite material according to the invention has defined soft-magnetic properties in the range of monolithic electric strip plates in comparison to composite materials known from the prior art.

Preferably, the composite material has a loss at P1.7; 50 Hz in the range from 0.60 to 1.0 W/kg, more preferably 0.60 to 0.90 W/kg, most preferably 0.60 to 0.8 W/kg and/or a field strength at J800 in the range from 1.88 to 1.96 T, more preferably 1.90 to 1.96 T determined according to DIN EN 60404-2.

Furthermore, it has surprisingly been found that the composite material according to the invention in the later field of application transformer has a comparable iron filling factor as in the current state of the art and thus shows no drop in performance.

Preferably, the iron filling factor in a transformer using the composite material according to the invention is 96.0 to 99.0%, more preferably 98.0 to 99.0%, even more preferably 98.3 to 99.0%.

The use of the composite material according to the invention not only actively allows a significant reduction in the resulting structure-borne noise in the transformer, but also allows an increased efficiency to be generated by, for example, varying the electric strip sheet thicknesses used.

The fact that the polymeric layer comprises a crosslinked acrylate-based copolymer of high molecular weight means that the vibrations and/or oscillations can be better absorbed and converted into heat energy. As a result, a significant reduction of the structure-borne noise is achieved, so that the use of secondary acoustic measures is significantly reduced or even eliminated completely.

The hysteresis losses of electric strip sheets are very dependent on the thicknesses of the sheets used. As a rule, the smaller the thickness of the electric strip, the lower the loss. By using the composite sheet according to the invention, two electric strips of correspondingly better quality with a thickness of 0.20 mm can be glued together, compared to an electric strip with a thickness of for example 0.40 mm. With respect to a transformer type, this can either significantly increase the efficiency of the transformer or allow the construction of a smaller transformer with the same efficiency.

In practice, the composite materials themselves, as well as the components produced therefrom, sometimes come into contact with various, sometimes very aggressive, oils which can attack the polymeric layer and thus lead to delamination. It is therefore desirable that the polymeric layer be resistant to such technical oils. Thus, it has been found that when the crosslinked acrylate-based copolymer of high molecular weight is preferably composed of a copolymerised mixture of at least one alkyl acrylate ester monomer unit and/or alkyl methacrylate ester monomer unit, wherein both have an alkyl group with 1 to 12 carbon atoms, a glycidyl monomer unit, an unsaturated carboxylic acid monomer unit and a crosslinker, no swelling of the polymeric layer or delamination of the composite material is apparent.

In a more preferred embodiment, the crosslinked acrylate-based copolymer of high molecular weight is composed solely of the two components, that is the copolymerised mixture and the crosslinker.

In a further preferred embodiment, the copolymerised mixture comprises at least one alkyl acrylate ester monomer unit and/or alkyl methacrylate ester monomer unit, wherein both have an alkyl group with 1 to 12 carbon atoms, a glycidyl monomer unit and an unsaturated carboxylic acid monomer unit.

Preferably, the glycidyl monomer unit is selected from the group consisting of allyl glycidyl ether, glycidyl acrylate ester, glycidyl methacrylate ester and/or mixtures thereof.

Preferably, the alkyl acrylate ester monomer unit and/or alkyl methacrylate ester monomer unit has an alkyl group with 4 to 12 carbon atoms.

If the polymeric layer has a glass transition temperature higher than −15° C., according to a preferred embodiment an alkyl acrylate ester monomer unit and/or alkyl methacrylate ester monomer unit with an alkyl group of 1 to 4 carbon atoms may be added to the mixture to be copolymerised.

In a preferred embodiment, the crosslinked acrylate-based copolymer of high molecular weight is composed of a copolymerised mixture of at least 55 to 85 wt % of an alkyl acrylate ester monomer unit and/or alkyl methacrylate ester monomer unit, both having an alkyl group with 4 to 12 carbon atoms, 0 to 35 wt % of an alkyl acrylate ester monomer unit and/or alkyl methacrylate ester monomer unit, both having an alkyl group of 1 to 4 carbon atoms, 0.01 to 2 wt % of a glycidyl monomer unit, 1 to 15 wt %, more preferably 3 to 13 wt % of an unsaturated carboxylic acid monomer unit, and 0.05 to 1 wt % of a crosslinker.

Preferably, the copolymerised mixture has a mean molar mass in the range from 500 to 1500 kDa, more preferably 600 to 1000 kDa, even more preferably 700 to 900 kDa, most preferably 800 kDa±20 kDa. The mean molar mass is determined by GPC. For calibration, the polystyrene standard was used.

Preferably, the alkyl acrylate ester monomer unit and/or alkyl methacrylate ester monomer unit with an alkyl group of 4 to 12 carbon atoms is selected from 2-ethylhexyl acrylate, isooctyl acrylate, acrylic acid butyl ester, 2-methylbutyl acrylate, 4-methyl-2-pentyl acrylate, isodecyl methacrylate, methyl acrylate, ethyl acrylate, methyl methacrylate and/or a mixture thereof.

Preferably, the unsaturated carboxylic acid monomer unit is selected from acrylic acid, methacrylic acid, fumaric acid and/or a mixture thereof. Preferred mixtures are composed of acrylic acid and methacrylic acid, of acrylic acid and fumaric acid or of methacrylic acid and fumaric acid.

According to a preferred embodiment, the copolymerisation is carried out with the aid of a solvent mixture, preferably a mixture of ethyl acetate and acetone. Preferably, the solvent mixture has a ratio that allows for reflux in the range from 68 to 78° C.

The solids content during the copolymerisation is preferably in the range from 40 to 60 wt %.

For the copolymerisation AIBN is preferably used as a radical initiator.

Furthermore, the copolymerisation is preferably carried out under a nitrogen atmosphere, so that a copolymer of high molecular weight, preferably having a mean molar mass of ≥500 kDa, is achieved.

Preferably, the crosslinker is selected from aluminium acetylacetonate (AlACA), iron acetylacetonate (FeACA), titanium acetylacetonate (TiACA) or zirconium acetylacetonate (ZrACA).

According to a further preferred embodiment, the electric strip layer has a layer thickness in the range from 50 to 1500 μm, more preferably in the range from 100 to 500 μm, even more preferably in the range from 150 to 350 μm and most preferably in the range from 180 to 270 μm.

To produce the composite material according to the invention, two electric strip layers with the same thickness or different thicknesses can be used.

According to another preferred embodiment, the grain-oriented electric strip layer has one or preferably 2 to 5, more preferably 2 to 3 surface layers respectively having a layer thickness in the range from 0.3 to 5 μm, more preferably 1 to 2.5 μm. The surface layer exerts a tensile stress on the iron silicate portion of the grain-oriented electric strip layer, so that the difference between the magnetic loss of the individual sheets and the finished transformer (so-called construction factor) is minimised.

Each layer may consist of a silicate, preferably a magnesium silicate, alternatively a phosphatic compound, preferably a phosphosilicate compound.

According to another preferred embodiment, the polymeric layer has a layer thickness in the range from 4 to 8 μm, more preferably in the range from 4.5 to 7.5 μm.

According to a further aspect, the present invention relates to a method for continuously producing a composite material comprising the method steps:
providing a first grain-oriented electric strip layer,
coating the first grain-oriented electric strip layer with a polymeric agent comprising a acrylate-based copolymer of high molecular weight and a crosslinker,
heating the coated first grain-oriented electric strip layer,
providing and heating a second grain-oriented electric strip layer,
laminating the two grain-oriented electric strip layers to obtain a composite material having a polymeric layer comprising a crosslinked acrylate-based copolymer of high molecular weight with a layer thickness in the range from 3 to 10 μm.

Preferably, the first grain-oriented electric strip layer and the second grain-oriented electric strip layer are provided as a coil, so that a continuous process for producing the composite material according to the invention can be realised.

Preferably, the coating of the first grain-oriented electric strip layer is carried out by a coater. As a result, a homogeneous layer of the polymeric agent is applied to the first grain-oriented electric strip layer. The application is made such that after the laminating step, the composite material has a polymeric layer with a layer thickness in the range from 3 to 10 μm, preferably 4 to 8 μm, more preferably in the range from 4 to 8 μm, and most preferably in the range from 4.5 to 7.5 μm.

According to a further preferred embodiment, a pretreatment of the first electric strip layer takes place between the step of providing the first electric strip layer and the application of the polymeric layer. Preferably, the pretreatment is a cleaning. Here, the surface of the electric strip used is freed from adhering dirt particles and oils and thus prepared for application of the polymeric agent.

In a preferred embodiment, the acrylate-based copolymer of high molecular weight is formed from a copolymerised mixture of at least one alkyl acrylate ester monomer unit and/or alkyl methacrylate ester monomer unit, both having an alkyl group of 1 to 12 carbon atoms, a glycidyl monomer unit, and an unsaturated carboxylic acid monomer unit.

Preferably, the electric strip layers are heated to a temperature in the range from 150 to 250° C., more preferably in the range from 160 to 190° C., more preferably in the range from 175 to 185° C. The heating of the electric strip layers can be done by conventional furnaces or by induction. Corresponding techniques are known to the person skilled in the art.

The two tempered electric strip layers are preferably laminated by means of a duplicating station. In this case, the first electric strip layer, to which the polymeric agent has been applied, is brought together with the second electric strip layer, so that the composite material according to the invention is obtained.

The still-hot composite material usually passes through a cooling section, where it cools to room temperature and is then wound into a coil.

According to a particularly preferred embodiment variant, in a next process step, a thermally activatable adhesive is applied by means of a coil coating method to one side, more preferably to both sides, of the composite material.

According to a further aspect, the present invention relates to a composite material produced by the method according to the invention.

Preferably, a composite material prepared in this way has soft-magnetic properties in the range of monolithic grain-oriented electric strip sheets compared to composite materials known from the prior art.

Preferably, the composite material has a loss at P1.7; 50 Hz in the range from 0.60 to 1.0 W/kg, more preferably 0.60 to 0.90 W/kg, most preferably 0.60 to 0.8 W/kg and/or a field strength at J800 in the range from 1.88 to 1.96 T, more preferably 1.90 to 1.96 T determined according to DIN EN 60404-2.

In a further aspect, the present invention relates to an iron core containing a plurality of lamellae of the composite material according to the invention.

In a further aspect, the present invention relates to a transformer comprising an iron core according to the invention.

Another aspect of the present invention further relates to a method for producing an iron core comprising the steps:
providing a composite material according to the invention,
separating a plurality of lamellae from the composite material, and
connecting the lamellae to an iron core.

The separation of the lamellae from the composite material, which is preferably in the form of a coil, can be carried out, for example, by means of a suitable punching or cutting tool. The separated lamellae are then stacked into a package and connected together.

The provision of a composite material which is preferably in the form of a coil affords a process advantage for the separation over the manufacture of the iron core using a monolithic electric strip sheet since only half of the separation steps are required to provide an iron core with the same number of lamellae.

The lamellae are preferably connected by means of punch bundeling, whereby a mechanical connection is produced between the individual lamellae. This connection is formed by elevations, which are punched into the individual lamellae.

According to a more preferred embodiment variant, the individual lamellae are glued together. Preferably, a thermally activatable adhesive is used for bonding. This can be activated before, during or after the stacking of the lamellae. Thus, the thermally activatable adhesive can be activated via the various process steps and thus brought into an adhesive state, so that a temporal and/or spatial separation is given.

Alternatively, it is also possible to use a baked enamel or a punctiform adhesive bond for gluing the lamellae together.

In a further aspect, the present invention relates to the use of the composite material according to the invention for producing an iron core for a transformer.

In the following the invention will be explained in more detail by means of examples.

### EXAMPLES

Various polymeric agents were prepared:

### Solution 1

For this purpose, a monomer solution of 207 g of acrylic acid butyl ester, 61.2 g of 2-ethylhexyl acrylate, 23.1 g of acrylic acid and 0.1 g of 2,3-epoxypropyl methacrylate was prepared. 68.5 g were then removed from the monomer solution and fed to a 1.5 litre reactor purged with nitrogen. The reactor was equipped with an agitator means, a reflux condenser and a thermistor. Subsequently, 29.7 g of ethyl acetate and 18 g of acetone were added to the monomer solution. The solution was heated under reflux. Then 0.05 g of AIBN (Dupont) was dissolved in 4.5 g of ethyl acetate and added to the refluxing solution. The solution was then held under strong reflux for 15 minutes. The remaining monomer solution was mixed with 195 g of ethyl acetate, 40 g of acetone and 0.24 g of AIBN and added constantly over 3 hours as a solution to the solution refluxing in the reactor. After completion of the addition, the solution was held under reflux for an additional hour. Subsequently, a solution of 0.12 g of AIBN, 9 g of ethyl acetate and 4 g of acetone was added to the reactor and the solution was refluxed for an additional hour. This process was repeated twice more. After completion of the addition, the solution was refluxed for an additional 1 hour. Subsequently, 178 g of toluene and 27 g of n-heptane were added. The crude product obtained had a solids content of 36 wt % and a viscosity of 8000 Pa s. The viscosity was determined by the Brookfield viscometer (#4 spindle, 12 rpm). The copolymer obtained consisted of 71 wt % of butyl acrylate, 21 wt % of 2-ethylhexyl acrylate, 8 wt % of acrylic acid and 0.03 wt % of 2,3-epoxypropyl methacrylate. The copolymer was then mixed with 0.1 wt % of aluminium acetylacetonate to obtain the polymeric agent.

### Solution 2

For this purpose, a monomer solution of 30 g of butylmethacrylate, 150 g of acrylic acid butyl ester, 27 g of ethyl methacrylate, 55 g of 2-ethylhexyl acrylate, 18.7 g of methacrylic acid and 0.1 g of 2,3-epoxypropyl acrylate was prepared. 75.5 g was then taken from the monomer solution and fed to a 1.5 litre reactor purged with nitrogen. The reactor was equipped with an agitator means, a reflux condenser and a thermistor. Subsequently, 32 g of ethyl acetate and 20 g of acetone were added to the monomer solution. The solution was heated under reflux. Then 0.05 g of AIBN (Dupont) was dissolved in 4.5 g of ethyl acetate and added to the refluxing solution. The solution was then held under strong reflux for 15 minutes. The remaining monomer solution was mixed with 195 g of ethyl acetate, 40 g of acetone and 0.24 g of AIBN and constantly added over 3 hours as a solution to the solution refluxing in the reactor. After completion of the addition, the solution was held under reflux for an additional hour. Subsequently, a solution of 0.12 g of AIBN, 9 g of ethyl acetate and 4 g of acetone was added to the reactor and the solution was refluxed for an additional hour. This process was repeated twice more. After completion of the addition, the solution was refluxed for an additional hour. Subsequently, 183 g of toluene and 27 g of n-heptane were added. The crude product obtained had a solids content of 38 wt % and a viscosity of 7500 Pa s. The viscosity was determined by the Brookfield viscometer (#4 spindle, 12 rpm). The resulting copolymer consisted of 10 wt % of butyl methacrylate, 53 wt % of butyl acrylate, 10 wt % of ethyl methacrylate, 20 wt % of 2-ethylhexyl acrylate, 6.5 wt % of methacrylate and 0.03 wt % of 2,3-epoxypropyl acrylate. The copolymer was then mixed with 0.1 wt % of aluminium acetylacetonate to obtain the polymeric agent.

### Solution 3 (Reference)

As a reference, a viscoelastic vibration-damping material ISD 110 from 3M was used. The application was carried out according to the data sheet with a film of 1 and 2 mils corresponding to min. 25 or 50 μm thickness. The adhesive was supplied in 25 and 50 μm thickness with a paper liner and contained no solvents. When heated, 5 to 30 μg/cm² volatiles (hydrocarbons, organic esters, esters, alcohols, acrylates, acetates, etc.) were outgassed. The application was carried out according to the data sheet. Air inclusions were avoided.

### Solution 4 (Reference)

Furthermore, a general-purpose adhesive from UHU® was used. This was a colourless crystal-clear gel and had a gel-like, thixotropic consistency. The formulation had a solids content of 32 wt % based on a polyvinyl ester having a density of 0.95 g/cm³. The solvent used was a mixture of low-boiling esters and alcohols. The formulation consisted of 50 to 70 wt % of methyl acetate and 5 to 10 wt % of ethanol and acetone.

### Example 1

A total of 20 transformer cores were built. In all the examples according to Table 1, a composite material was produced using two grain-oriented electric strips of the electric strip grade 23HP85D (nominal thickness 230 μm) or 27HP85D (nominal thickness 270 μm), and of the respective polymeric agent.

For this purpose, grain-oriented electric strips were coated for solutions 1, 2 and 4 by means of a coater with the adhesive system in the specified layer thicknesses. For solution 3, the correspondingly thick, solid adhesive layer was applied bubble-free to the grain-oriented electric strips using a roller. The material was then pre-dried for 1 min at 110° C. to remove the solvent. For the lamination process with the solutions 1 to 4 according to Table 1, the corresponding electric strips were then heated in a continuous furnace (furnace time approx. 50 s) to approx. 180° C. Immediately after reaching the PMT (peak metal temperature) these were laminated under pressure in a roller mill with grain-oriented electric strip sheets also heated to 180° C. For solution 3, a layer thickness of approx. 50 μm was achieved by laminating two coated grain-oriented electric strips together.

From 0.8 t (for the 230 μm thick sheets) or 48 t (for the 270 μm thick sheets) of the composite material, transformers with 3 legs were built according to the prior art and characterised in terms of noise according to EN60076-10.

TABLE 1

| | | | | | | Sound of | | |
|---|---|---|---|---|---|---|---|---|
| | | P1.7 of the | | | | the core at | | |
| | | starting | J800 of the | | | 1.5 T measured | Core | |
| | Electric | material/ | starting | | Transformer | according to | losses at | |
| Example | strip grade | WK g−1 | material/T | Polymeric layer | core weight | EN60076-10 | 1.5 T | |
| 1 | 23HP85D | 0.71 | 1.94 | 3 μm solution 1 | 0.8 t | 30 | 0.73 | According to |
| 2 | 23HP85D | 0.77 | 1.92 | 5 μm solution 1 | 0.8 t | 33 | 0.79 | the invention |
| 3 | 23HP85D | 0.73 | 1.93 | 3 μm solution 2 | 0.8 t | 31 | 0.74 | |
| 4 | 23HP85D | 0.76 | 1.92 | 6 μm solution 2 | 0.8 t | 32 | 0.78 | |
| 5 | 23HP85D | 0.73 | 1.94 | 9 μm solution 1 | 0.8 t | 31 | 0.76 | |
| 6 | 23HP85D | 0.79 | 1.90 | 4 μm solution 1 | 0.8 t | 35 | 0.82 | |
| 7 | 27HP85D | 0.80 | 1.95 | 9 μm solution 2 | 48 t | 53 | 0.84 | |
| 8 | 27HP85D | 0.83 | 1.92 | 3 μm solution 2 | 48 t | 55 | 0.86 | |
| 9 | 27HP85D | 0.86 | 1.91 | 3 μm solution 1 | 48 t | 51 | 0.90 | |
| 10 | 23HP85D | 0.83 | 1.93 | 3 μm solution 1 | 0.8 t | 52 | 0.84 | |
| 11 | 23HP85D | 0.71 | 1.94 | — | 0.8 t | 38 | 0.73 | Reference |
| 12 | 23HP85D | 0.77 | 1.92 | — | 0.8 t | 43 | 0.78 | |
| 13 | 27HP85D | 0.80 | 1.95 | — | 48 t | 61 | 0.83 | |
| 14 | 27HP85D | 0.83 | 1.92 | — | 48 t | 62 | 0.85 | |
| 15 | 23HP85D | 0.71 | 1.94 | 50 μm solution 3 | 0.8 t | 31 | 0.80 | |
| 16 | 23HP85D | 0.77 | 1.92 | 50 μm solution 3 | 0.8 t | 34 | 0.87 | |
| 17 | 23HP85D | 0.71 | 1.94 | 25 μm solution 3 | 0.8 t | 37 | 0.75 | |
| 18 | 23HP85D | 0.77 | 1.92 | 25 μm solution 3 | 0.8 t | 42 | 0.80 | |
| 19 | 23HP85D | 0.76 | 1.92 | 5 μm solution 4 | 0.8 t | 43 | 0.85 | |
| 20 | 23HP85D | 0.73 | 1.94 | 9 μm solution 4 | 0.8 t | 41 | 0.80 | |

Furthermore, the stability of the polymeric layer was examined. For this purpose, test specimens (2.5×10 cm) correspondingly cut to size from the obtained composite material were placed into a corresponding test liquid (gear oil Shell ATF 134 FE, transformer oil Nynas Nytro Taurus (IEC 60296) Ed. 4—standard grade) for 164 h at 120° C. At the end of the exposure time, the test specimens were examined visually. In this case, neither a delamination nor a swelling of the polymeric layer could be detected.

### BRIEF DESCRIPTION OF THE DRAWINGS

In the following the invention will be explained in more detail with reference to drawings. These show in detail:

FIG. 1 a first embodiment variant of the composite material according to the invention,

FIG. 2 a second embodiment variant of the composite material according to the invention,

FIG. 3 a multilayer structure using the composite material according to the second embodiment variant and

FIG. 4 a process diagram for the production of the composite material according to the invention.

### DESCRIPTION OF THE PREFERRED EMBODIMENTS

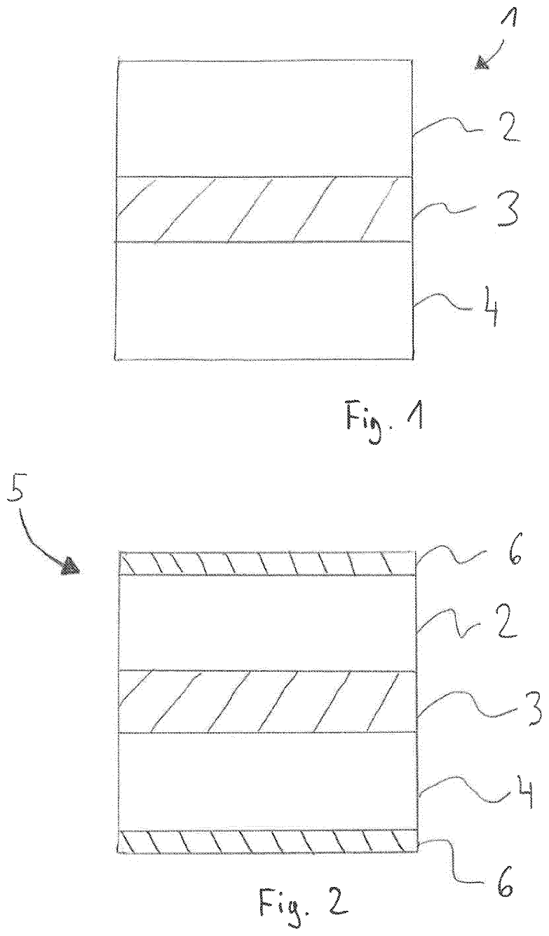

In FIG. 1, a three-layer structure of a composite material 1 according to the invention and according to a first embodiment is shown. The composite material 1 comprises a first electric strip layer 2, a second electric strip layer 4 and a polymeric layer 3 arranged therebetween.

FIG. 2 shows a second embodiment variant of the composite material 5 according to the invention with a first and second electric strip layer 2, 4 and a polymeric layer 3 arranged therebetween. On the opposite side to polymeric layer 3, the two electric strip layers 2, 4 respectively have an insulation layer 6. According to a preferred embodiment variant, this is formed by a thermally activatable adhesive.

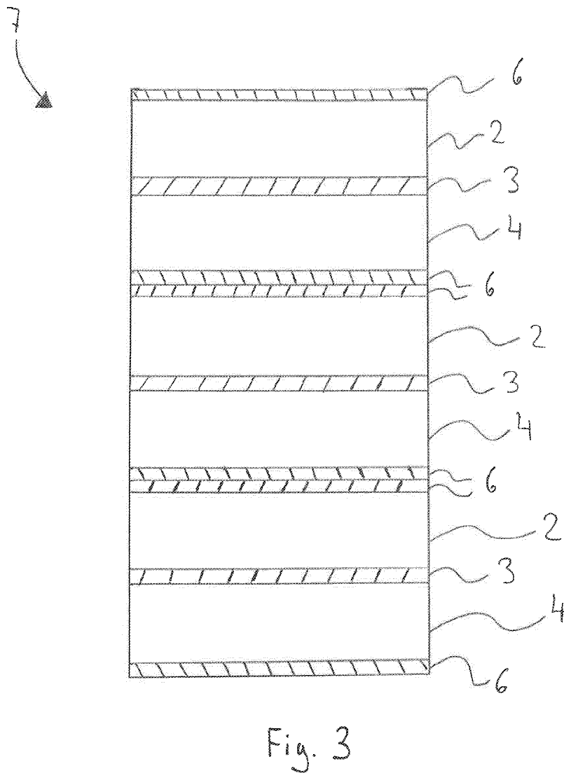

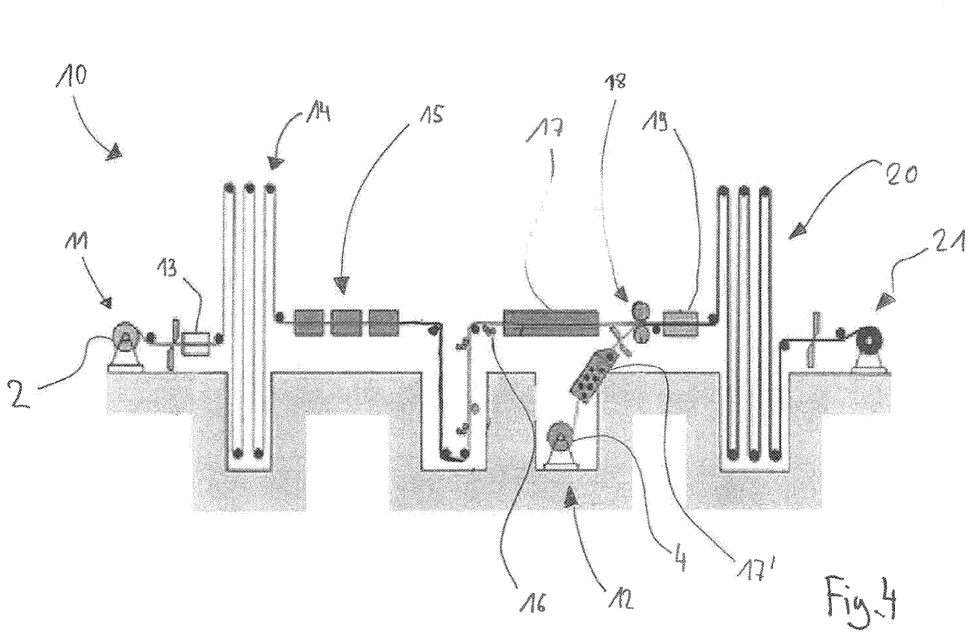

In FIG. 3, a multilayer structure 7 is shown using the composite material 5 according to the second embodiment variant. The individual layers of the composite material 5 are in this case arranged one above the other to form a stack. If the insulation layer 6 is formed by a thermally activatable adhesive, the multilayer structure 7 has a homogeneous insulation layer 6 between the individual lamellae (not shown).

FIG. 4 shows a process diagram for the continuous production of the composite material 1, 5 according to the invention by means of a strip coating system 10. The system 10 has a first and a second strip unwinding station 11, 12, with which a first and second grain-oriented electric strip layer 2, 4 is provided. Furthermore, the system 10 has a stapling device 13 and a first and second strip accumulator 14, 20, which allow a change of a coil without requiring the process to be interrupted. If necessary, the first electric strip layer 2 is first added to a pretreatment stage 15 in order to free the surface of the electric strip layer 2 from adhering dirt particles and oils. Subsequently, the polymeric agent (not shown) is applied on one side via an applicator roller 16. The electric strip layer 2 coated with the polymeric agent then passes through a 2-zone furnace 17, in which the applied coating is pre-dried at 100-120° C. In this case, the solvent is removed. In the second zone of the furnace 17, the electric strip layer 2 is heated to the PMT (170-190° C.). Furthermore, a second electric strip layer 4 is provided by the second unwinding station 12 and first fed to a heating station 17, in which the second electric strip layer 4 is likewise heated to the PMT. In a duplicating station 18, the two electric strip layers 2, 4 are laminated together under a pressure of 5 kN and at a temperature of 150-170° C. to form the composite material 1, 5. Subsequently, the still-hot composite material 1, 5 passes through a cooling station, where it cools to room temperature and is then wound into a coil on a strip winding station 21.

### LIST OF REFERENCE NUMERALS

1 Composite material
2 First electric strip layer
3 Polymeric layer
4 Second electric strip layer
5 Composite material
6 Insulation layer
7 Multilayer design
10 Strip coating system
11 Strip unwinding station
12 Strip unwinding station
13 Stapling device
14 Strip accumulator
15 Pretreatment stage
16 Applicator roller
17 Heating station
18 Duplicating station
19 Cooling station
20 Strip accumulator
21 Strip winding station

1. A composite material for use in a transformer, the composite material comprising:
a first grain-oriented electric strip layer and a second grain-oriented electric strip layer; and
a polymeric layer arranged between the first grain-oriented electric strip layer and the second grain-oriented electric strip layer,
wherein the polymeric layer comprises a crosslinked acrylate-based copolymer of high molecular weight and has a layer thickness in the range from 3 to 10 μm.

2. The composite material according to claim 1, wherein the crosslinked high molecular weight acrylate-based copolymer comprises a copolymerized mixture of at least:
at least one of an alkyl acrylate ester monomer unit and alkyl methacrylate ester monomer unit, wherein each unit has an alkyl group with 1 to 12 carbon atoms;
a glycidyl monomer unit;
an unsaturated carboxylic acid monomer unit; and
a crosslinker.

3. The composite material according to claim 2, wherein the copolymerised mixture has a mean molar mass in the range from 500 to 1500 kDa.

4. The composite material according to claim 1, wherein the first grain-oriented electric strip layer and the second grain-oriented electric strip layer have a layer thickness in the range from 50 to 1500 μm.

5. The composite material according to claim 1, wherein the first grain-oriented electric strip layer and the second grain-oriented strip layer have an insulation layer with a layer thickness in the range from 0.5 to 2 μm.

6. A method for continuously producing a composite material, the method comprising the steps of:
providing a first grain-oriented electric strip layer;
coating the first grain-oriented electric strip layer with a polymeric agent comprising an acrylate-based copolymer of high molecular weight and a crosslinker;
heating the coated first grain-oriented electric strip layer;
providing and heating a second grain-oriented electric strip layer; and
laminating the first and the second grain-oriented electric strip layers to obtain a composite material having a polymeric layer comprising a crosslinked acrylate-based copolymer of high molecular weight having a layer thickness in the range from 3 to 10 μm.

7. The method according to claim 6, wherein the acrylate-based copolymer of high molecular weight is formed from a copolymerised mixture of:
at least one of an alkyl acrylate ester monomer unit and an alkyl methacrylate ester monomer unit, wherein each unit has an alkyl group with 1 to 12 carbon atoms;
a glycidyl monomer unit; and
an unsaturated carboxylic acid monomer unit.

8. The method according to claim 6, wherein the first and the second grain-oriented electric strip layers are heated to a temperature in the range from 150 to 250° C.

9. A composite material produced by the method according to claim 6.

10. The composite material according to claim 9, having a loss at P1.7; 50 Hz in the range from 0.60 to 1.0 W/kg and/or a field strength at J800 in the range from 1.88 to 1.96 T determined in accordance with DIN EN 60404-2.

11. (canceled)

12. (canceled)

13. A method for producing an iron core for a transformer, the method comprising the steps of:
providing a composite material comprising:
a first grain-oriented electric strip layer and a second grain-oriented electric strip layer; and
a polymeric layer arranged between the first grain-oriented electric strip layer and the second grain-oriented electric strip layer,
wherein the polymer layer comprises a crosslinked acrylate-based copolymer or high molecular weight and has a thickness in the range from 3 to 10 82 m,
separating a plurality of lamellae from the composite material; and
connecting the lamellae to an iron core.

14. The method according to claim 13, wherein the lamellae are connected by a thermally activatable adhesive.

15. (canceled)

16. An iron core for a transformer produced by the method according to claim 13.
